(19) United States
(12) Patent Application Publication
(10) Pub. No.: US 2009/0237379 A1
(43) Pub. Date: Sep. 24, 2009

(54) AUTOMATICALLY CONFORMING THE ORIENTATION OF A DISPLAY SIGNAL TO THE ROTATIONAL POSITION OF A DISPLAY DEVICE RECEIVING THE DISPLAY SIGNAL

(76) Inventor: Steven D. Lawrenz, (US)

Correspondence Address: STEVEN D. LAWRENZ, 11 W. RAYE ST., SEATTLE, WA, 98119, US

(21) Appl. No.: 12/053,594

(22) Filed: Mar. 22, 2008

(51) Int. Cl. G06F 3/038

(52) U.S. Cl. 345/204

(57) ABSTRACT

An add-on module is described. The add-on module is comprised of an attachment mechanism, an orientation detection subsystem, and a communication subsystem. The attachment mechanism is adapted to be usable by an end user of a display device to directly attach the add-on module to the display device. The orientation detection subsystem detects the rotational orientation of the display device. The communication subsystem communicates to a video source from which the display device receives a video signal notifications of the rotational orientation of the display device detected by the orientation detection subsystem. This enables the video source to, upon receiving each notification of the rotational orientation of the display device detected by the orientation detection subsystem, conform to the notification's rotational orientation the rotational orientation of the video signal received from the video source.

### TECHNICAL FIELD

The described technology is directed to the field of video displays.

### BACKGROUND

A video display device (“display device”) displays a 2- or 3-dimensional dynamic image, such as that produced by a computer system, a DVD player, a video game console, or a television tuner. Display devices typically display an image by controlling the visual characteristics of each of a grid of visual elements, called “pixels.”

In many display devices, there is some variation—or “asymmetry”—between two of the display device's dimensions. A typical asymmetry is that the size of the pixel grid in one dimension is larger than in another dimension. Displays having such pixel grid asymmetry are said to be in a portrait orientation when the size of their pixel grid is larger in the vertical dimension than in the horizontal dimension, whereas such displays are said to be in a landscape orientation when the size of their pixel grid is larger in the horizontal dimension than in the vertical dimension.

Such asymmetries lend significance to the rotational orientation of the display device. For example, the most effective display device for the office of a professional document editor may be one designed for use in a portrait orientation to best accommodate the dimensions of typical documents, whereas the most effective display device for the screening room of a film director may be one designed for use in landscape orientation to best accommodate the dimensions of typical films.

It is physically possible to position many displays in either a landscape or a portrait orientation. For example, in order to better display a document laid out in landscape orientation, the document editor may be able to pick up his display device, rotate it from portrait to landscape orientation, and set it down on his desk in landscape orientation. In fact, some displays incorporate a pivot joint designed to facilitate rotation between landscape and portrait orientations. When a user rotates a display device in any of these manners, however, the user typically must manually adjust the device producing the image being displayed by the display device. For example, where the device producing the image being displayed by the display device is a computer system, the user must typically perform some interactions with the computer to cause it to produce the image in an orientation matching the new orientation of the display device, such as by modifying a video driver setting.

### BRIEF DESCRIPTION OF THE DRAWINGS

FIG. 1 is a display diagram showing the display of a landscape video signal on a display in landscape orientation.

FIG. 2A is a display diagram showing the display of a landscape video signal on a display in portrait orientation.

FIG. 2B is a display diagram showing the display of a portrait video signal on a display in portrait orientation.

FIG. 3 is a rear isometric view of the display device in landscape orientation.

FIG. 4 is a rear isometric view of the display device in portrait orientation.

FIG. 5 is a block diagram showing some of the components typically incorporated in at least some of the computer systems and other devices on which the facility executes.

FIG. 6 is a flow diagram showing steps performed by the orientation sensor in some embodiments.

FIG. 7 is a flow diagram showing steps performed by the computer system or other video signal generating device in some embodiments.

### DETAILED DESCRIPTION

The inventor has recognized that these interactions to manually adjust the device producing the image being displayed by the display device to cause it to produce the image in an orientation matching the new orientation of the display device are often burdensome or otherwise inconvenient, and provide a disincentive to rotating the display in a way that could be advantageous to the user. Accordingly, the inventor has recognized that a solution for automatically conforming the orientation of a display signal to the rotational position of a display would have significant utility.

A facility for automatically conforming the orientation of a display signal to the rotational position of a display device receiving the display signal (“the facility”) is described. In some embodiments, the facility provides an orientation sensor that may be straightforwardly attached to a display device by an end user, permitting the facility to be provided as an aftermarket enhancement—i.e., an “add-on”—to a standard display device. When the orientation sensor detects a change in the orientation of the display device, it reports the display device's new orientation to the device generating the display signal. The facility automatically causes this generating device to reorient the generated display signal to conform the orientation of the generated display sign to the new orientation of the display device reported by the orientation sensor.

Many display devices are equipped with one or more Universal Serial Bus (“USB”) ports. When such a display device is connected to a USB port of a computer system or other device, any device that in connected to a USB port of the display device behaves as if it is connected directly to a USB port of the computer system. For example, a USB flash drive that is connected to a USB port of such a display device behaves as if it is connected directly to a USB port of the computer system, permitting a user of the computer system to read from and write to the USB flash drive.

In some embodiments, the facility provides an orientation sensor that is connected to a USB port on the display device. Such connection to the USB port on the display device provides both (1) physical attachment to the display device that causes the orientation sensor to rotate when the display device is rotated, and (2) communicative connectivity, via the USB established by the generating device through the display device, that enables the orientation sensor to communicate changes in its orientation and/or position, and thus the display device's orientation, to the generating device. As is described further below, however, in various other embodiments, the facility uses various other approaches to providing either or both of these functions.

In the generating device, a driver associated with the orientation sensor receives orientation reports from the orientation sensor. Each time the driver receives an orientation report from the orientation sensor, the orientation sensor driver causes the generating device to transition to an orientation for its display signal conforming to the display device orientation reported in the orientation report, such as by instructing a video driver responsible for selecting an orientation used by the generating device's video hardware to select a conforming orientation. As is described further below, however, in various other embodiments, the facility uses various other approaches to causing the generating device to transition to an orientation for its display signal conforming to the display device orientation reported in the orientation report.

By operating in some or all of the manners described above, the facility permits a user to easily update a standard display device in a way that causes it to automatically match the orientation of the image displayed on it to its physical orientation, significantly reducing the disincentive associated with reorienting the display device.

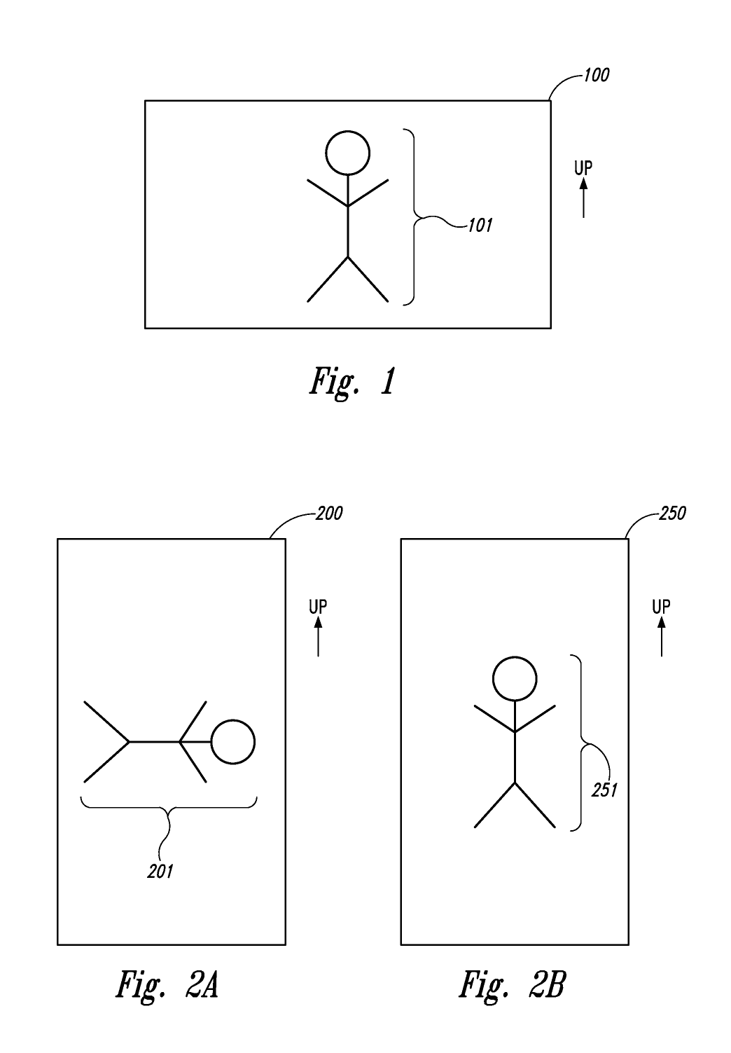

FIGS. 1-2B illustrate different relative rotational orientations between the video signal and display device. FIG. 1 is a display diagram showing the display of a landscape video signal on a display in landscape orientation. It can be seen that the horizontal dimension of the display 100 is larger than the vertical dimension. It can further be seen that human FIG. 101 included in the video signal appears to be displayed upright.

FIG. 2A is a display diagram showing the display of a landscape video signal on a display in portrait orientation. It can be seen that, subsequent to a 90-degree clockwise rotation of display 100 shown in FIG. 1, the vertical dimension of the display 200 is larger than the horizontal dimension. It can further be seen that human FIG. 201 included in the video signal appears to be displayed sideways.

FIG. 2B is a display diagram showing the display of a portrait video signal on a display in portrait orientation. It can be seen that, subsequent to the time shown in FIG. 2A, the facility automatically rotated the video signal from landscape to portrait. It can further be seen that human FIG. 251 included in the video signal again appears to be displayed upright, enabling the user to continue his or her work without having to manually manipulate the video source to rotate the video signal.

In contrast to the example shown in these figures, however, one skilled in the art can appreciate that, in some embodiments, the facility causes the video signal to be rotated before rotation of the display device is complete rather than after.

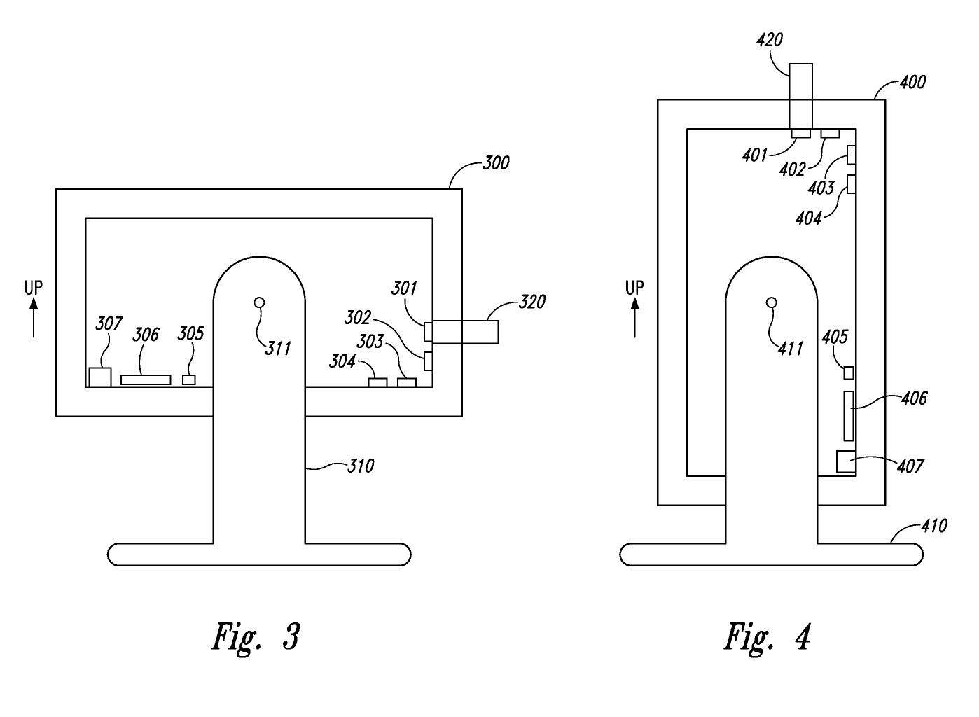

FIGS. 3 and 4 show the attachment of the add-on module to the display device. FIG. 3 is a rear isometric view of the display device in landscape orientation. The display device 300 shown is one designed to pivot relative to its base 310 using a joint 311 to facilitate switching between landscape and portrait orientations, such as a Dell 2001FP or a NEC MultiSync LCD1880SX. Those skilled in the art will appreciate, however, that the facility may be used with a wide variety of displays, including those that, while not specifically designed to facilitate their rotation, may nonetheless be positioned in portrait or landscape orientation.

FIG. 3 shows a pair of USB ports 301 and 302 that face to the side in landscape orientation, as well as a pair of USB ports 303 and 304 that face down in landscape orientation. A user may plug a USB device into each of these USB ports, such as a mouse, a keyboard, a microphone, a video camera, an audio recorder, a compact flash drive, etc. The display device contains a USB hub or switch (not shown) that connects each of the USB ports 301-304 to a USB miniconnector 305. When a cable is used to connect the USB miniconnector to a USB port on a USB host, such as the computer system with which the display device is used, any USB device connected to one of the USB ports 301-304 behaves as if directly to the USB port on a USB host.

FIG. 3 further shows a video connector 306, such as a DVI or a VGA connector that may be connected by a video cable to a video source, i.e., the “video signal generating device”—such as the computer system with which the display device is used—to provide a video signal. FIG. 3 further shows a power connector 307 to which a power cable may be connected to provide power to the display device.

FIG. 3 further shows an orientation sensor 320 attached to USB port 301. The orientation sensor is attached to the USB port both in that (1) it is physically attached to the display device such that the orientation sensor rotates and/or moves to a new location relative the display device's base and its surroundings when the display device is rotated, and (2) it is communicatively connected, via the USB established by the generating device through the display device, enabling the orientation sensor to communicate changes in its rotational orientation and/or location, and thus the display device's orientation, to the generating device. It can be seen that, while the display device is in landscape orientation, the larger dimension of the orientation sensor is horizontal.

In some embodiments, the body of the orientation sensor is rotatable about one or more axes relative to its USB connector, enabling it to be aligned to detect rotation in a plane corresponding to the plane in which the display device rotates, and/or to better assess its location. In some embodiments, the orientation sensor is designed to detect rotation and/or determine when its body is in any position, such as by using omnidirectional and/or redundant sensing elements.

In some embodiments, the act of connecting the orientation sensor to the USB port causes a device driver for the orientation sensor to be installed on the computer system with which the display is being used. In some embodiments, this automatic installation is performed in accordance with the Universal Plug and Play Device Control Protocol described at www.upnp.org. In some embodiments, the installed device driver is retrieved from nonvolatile memory contained in the orientation sensor, such as flash memory. In some embodiments, the orientation sensor causes the computer system to retrieve the device driver that is installed from a server via the Internet, or from separate physical media.

FIG. 4 is a rear isometric view of the display device in portrait orientation. This orientation may be reached from the orientation shown in FIG. 3 by rotating the display device 90 degrees in what appears to be the counterclockwise direction from the rear, and what appears to be the clockwise direction from the front. It can be seen that, while the display device is in portrait orientation, the larger dimension of the orientation sensor 420 is vertical.

During or immediately after the described rotation, the orientation sensor detects a change in its own rotation orientation and/or location, and signals its device driver to this effect. In response, the orientation sensor's device driver instructs one or more components of the computer system responsible for generating the video signal—such as the video driver or video card—to rotate the video signal being generated by the computer system to conform it to the new rotational orientation of the display device.

In various embodiments, the orientation sensor is physically connected to the display device in a variety of ways, including via USB connector or other communication connector, via power connector, via adhesive fastener, via hook-and-loop fastener, or by an expanding physical connector adapted to be pressed into a small aperture in an exterior surface of the display device.

In various embodiments, the orientation sensor uses a variety of techniques to detect a change in its own rotation orientation and/or location: an orientation sensing element that determines orientation of the orientation sensor relative to such directions as the direction in which gravity acts, the direction of a natural or artificial magnetic field, the direction of a light source, the direction of an audio source, or the direction of a source of radio energy; a proximity sensing element that determines proximity of the orientation sensor relative to such points as the source of gravity, the source of a natural or artificial magnetic field, a source of light, an audio source, or a source of radio energy; an image sensing element that senses the orientation of an image or pattern relative to which the display device rotates; a rotational motion sensing element that senses rotational motion of the orientation sensor; a rotational acceleration sensing element that senses rotational acceleration of the orientation sensor; a linear motion sensing element that senses linear motion of the orientation sensor; a linear acceleration sensing element that senses linear acceleration of the orientation sensor; as well as a variety of other techniques known to those of skill in the art.

In some embodiments, the orientation sensor is equipped with sensing elements that support multiple techniques. In these embodiments, the facility combines the results obtained for the different enabled techniques, such as by weighting them equally; weighting them based on their proven relative levels of success; or weighting them based on a determination of varying conditions (e.g., the facility may attribute a weight to the result for an optical sensor that varies directly with total light received, so as to discount its results when the display device is in the dark).

In various embodiments, the orientation sensor uses a variety of techniques to transmit indications of change in the rotational orientation of the display device. In some embodiments, the orientation sensor communicates via a wired USB connection; a firewire connection; a desktop bus connection; a wireless USB connection; a Bluetooth connection; a WiFi connection; an Ethernet connection; the video cable; or the power cable.

In some embodiments, the orientation sensor is equipped to use multiple transmission techniques. In some such embodiments, the orientation sensor transmits every indication via all available transmission techniques. In some such embodiments, the facility transmits indications via fewer than all available transmission techniques, such as by testing the different transmission techniques and using the most successful transmission technique, or by selecting the available transmission technique that uses the least of a scarce resource such as electrical power, data-carrying capacity, etc.

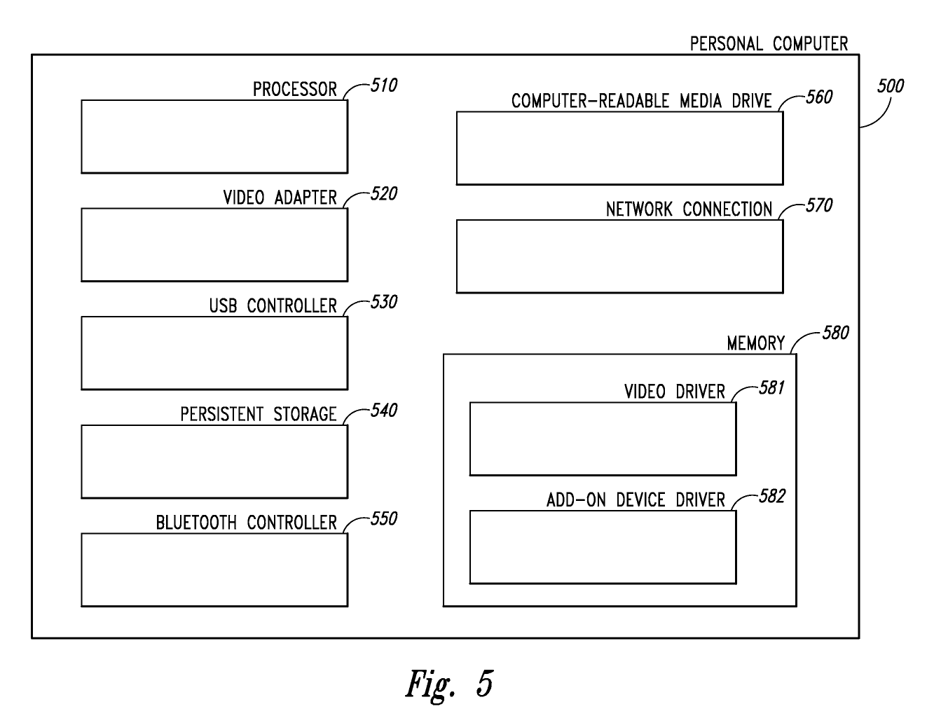

FIG. 5 is a block diagram showing some of the components typically incorporated in at least some of the computer systems and other devices on which the facility executes. These computer systems and devices 500 may include one or more central processing units (“processors”) 510 for executing computer programs; a video adapter 520, such as one or more video cards, for generating a video signal for a display device; a USB controller 530 for serving as a USB host to USB devices connected to one or more USB ports (not shown); a persistent storage device 540, such as a hard drive for persistently storing programs and data; a bluetooth controller 550 for serving as a Bluetooth host to nearby bluetooth devices via a bluetooth antenna (not shown); a computer-readable media drive 560, such as a CD-ROM drive, for reading programs and data stored on a computer-readable medium; a network connection 570 for connecting the computer system to other computer systems, such as via the Internet; and a computer memory 580 for storing programs and data while they are being used. The computer memory may contain a video driver program 581 for controlling the video adapter, as well as a device driver 582 for the orientation sensor. While computer systems configured as described above are typically used to support the operation of the facility, those skilled in the art will appreciate that the facility may be implemented using devices of various types and configurations, and having various components.

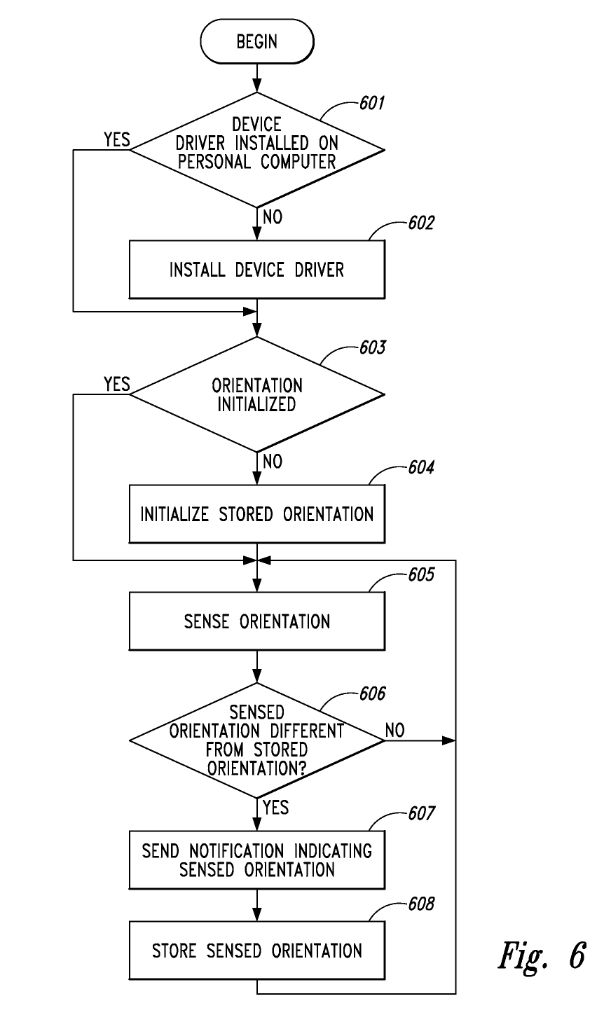

FIG. 6 is a flow diagram showing steps performed by the orientation sensor in some embodiments. In step 601, if the orientation sensor device driver is installed on the computer system, then the facility continues in step 603, else the facility continues in step 602. In step 602, the facility installs the orientation sensor device driver on the computer system.

In step 603, if the orientation of the display device has been initialized, then the facility continues in step 605, else the facility continues in step 604. In step 604, and/or at one or more later times, the facility initializes the orientation sensor. In some embodiments, this involves prompting the user to rotate the display device to each of two or more rotational orientations, and use an input device such as keyboard, mouse, or voice to identify these orientations. For example, the user may rotate the display device to landscape orientation, then click a button marked landscape, then rotate the display device to portrait orientation, then click a button marked portrait. In some embodiments, text in these buttons is displayed simultaneously in multiple rotational orientations. In some embodiments, the buttons contain direction indicators such as figures or arrows that identify different directions as up. For the time up to and including each of these button clicks, the facility collects raw feedback from the orientation sensor. The facility then generalizes this feedback and associates it with the rotational orientation corresponding to the button, enabling the facility to map future raw feedback from the orientation sensor to a rotational orientation of the display device.

In step 605, the facility uses the initialized orientation sensor to sense the orientation of the display device. In step 606, if the sensed orientation differs from a prior stored orientation, the facility continues in step 607, else the facility continues in step 605 to again sense the orientation of the display device.

In step 607, the facility sends a notification from the orientation sensor to the video source indicating the new orientation sensed in step 605. In step 608, the facility stores the new sensed orientation as the current orientation. After step 608, the facility continues in step 605 to again sense the orientation of the display device.

Those skilled in the art will appreciate that the steps shown in FIG. 6 and in each of the flow diagrams discussed below may be altered in a variety of ways. For example, the order of the steps may be rearranged; substeps may be performed in parallel; shown steps may be omitted, or other steps may be included; etc.

In some embodiments, the facility omits steps 606 and 608, periodically sending a notification of the current rotational orientation of the display device irrespective of whether it has changed. In embodiments in which the orientation sensor directly senses motion or acceleration rather than rotational position or location, the facility merely waits for sensor output indicating motion or acceleration, then determines and reports rotational orientation of the display device on its basis.

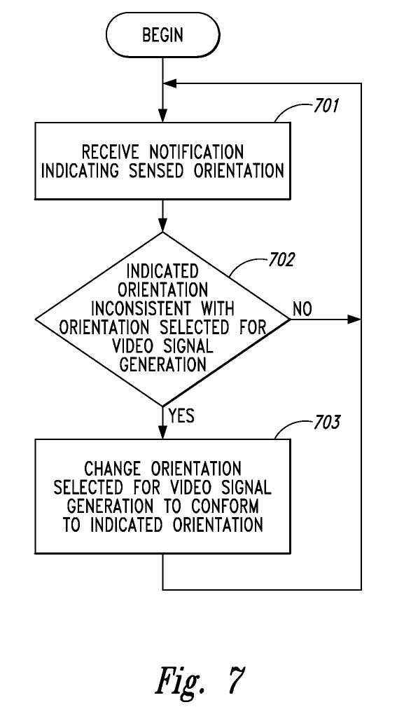

FIG. 7 is a flow diagram showing steps performed by the computer system or other video signal generating device in some embodiments. In some embodiments, these steps are performed in the orientation sensor device driver. In step 701, the facility receives a notification from the orientation sensor indicating a sensed orientation. In step 702, if the orientation indicated by the notification received in step 701 is inconsistent with the orientation presently selected for video signal generation in the video signal generating device, then the facility continues in step 703, else the facility continues in step 701. In step 703, the facility changes the orientation selected for video signal generation in the video signal generating device to conform to the orientation indicated by the notification received in step 701. After step 703, the facility continues in step 701.

In some embodiments, the facility uses a directional passive radio transponder, such as an RFID tag, attached to the display device by a means such as an adhesive coating. In such embodiments, an active radio transceiver that does not move with the display device determines the location and/or orientation of the transponder based upon the signal it receives from the transponder. In some such embodiments, the transponder includes one single-dipole antenna that is only effective to receive the transceiver's signal, energize the transponder's circuitry, and transmit a response when the orientation of the transponder, and therefore the display device, is within a limited tolerance of an idealized orientation-when the transceiver receives a response, the facility understands the display device to be in a first orientation; when the transceiver does not receive a response, facility understands the display device to be in an orientation other than the first orientation. In some such embodiments, the transponder includes two or more single-dipole antennas, and the transponder's response encodes the relative strength of the signals received via the different antennas-when the transceiver receives a response, the facility decodes the response to determine the relative strength of the signals received via the different antennas to determine the orientation of the transponder, and therefore the display device. In some such embodiments, the transponder includes an omnidirectional antenna, and the facility determines the orientation of the display device based upon the strength of the response signal received by the transceiver—related inversely to the distance between the transponder and the transceiver's antenna—and/or the response time of the response signal received by the transceiver—related inversely to the distance between the transponder and the transceiver's antenna. In such embodiments, the transceiver is connected to the video source. For example, the transceiver may be included in an expansion card installed in an expansion slot of a computer system, or may be separate from the video source, communicationally attached to it, such as via a USB connection. In some embodiments, the transceiver's antenna is physically integrated into the transceiver, while in others it is independent of the transceiver. In some embodiments, the transceiver's antenna is reorientable relative to the display device.

It will be appreciated by those skilled in the art that the above-described facility may be straightforwardly adapted or extended in various ways. While the foregoing description makes reference to particular embodiments, the scope of the invention is defined solely the elements directly recited by the claims that follow.

1-2. (canceled)

3. A display system in which the rotational orientation of a video signal generated by a video source is automatically conformed to a rotational position of a display device, comprising:
the display device comprising:
a video input interface that receives a video signal from the video source, and
a display mechanism causing an image specified by the video signal to be visually displayed, and
an add-on module that is directly physically attached to the display device by an end user, the add-on module comprising:
an orientation detection subsystem that detects the rotational orientation of the add-on module, and
a communication subsystem that communicates to the video source notifications of the rotational orientation of the add-on module detected by the orientation detection subsystem,
such that the video source may, upon receiving each notification of the rotational orientation of the add-on module detected by the orientation detection subsystem, conform to the notification's rotational orientation the rotational orientation of the video signal received from the video source.

4-25. (canceled)

26. A data transmission network conveying a display orientation data structure, the data structure containing an indication of a rotational orientation of an add-on module directly attached to a display device displaying an image that is predictably related to the rotational orientation of the display device, such that, if the data structure is received by a video source supplying the displayed image, the video source may rotate the displayed image it is supplying to correspond to the rotational orientation indicated by the data structure.

27. A video source device, comprising:
a video signal generation subsystem that generates a video signal based upon a video feed and a selected rotational orientation;
a communication subsystem that receives rotational orientation signals from an add-on module physically attached to a display device receiving the video signal generated by the video signal generation subsystem; and
a rotational orientation selection subsystem that periodically selects a rotational orientation correlated to the received rotational orientation signals.

28. A computer-readable medium containing a device driver for an add-on module for a display device, the device driver causing a computing system upon which it is installed to perform a method comprising:
receiving a message from the add-on module containing an indication of the rotational orientation of the add-on module; and
if a rotational orientation maintained by the computing system and used by the computing system to generate a video signal is inconsistent with the indication of the rotational orientation of the add-on module, conforming the rotational orientation maintained by the computing system to the indication of the rotational orientation of the add-on module.

29. The computer-readable medium of claim 28 wherein the computer-readable medium is contained in the add-on module.

30. The computer-readable medium of claim 28 wherein the device driver is adapted for installation on a personal computer.

31. The computer-readable medium of claim 28 wherein the device driver is adapted for installation on a video game console.

32. The computer-readable medium of claim 28 wherein the device driver is adapted for installation on a digital video recorder.

33. The computer-readable medium of claim 28 wherein the device driver is adapted for installation on a cable television set-top box.

34. The computer-readable medium of claim 28 wherein the device driver is adapted for installation on a digital video disk player.

35. The computer readable medium of claim 28 wherein the method further comprises presenting a control usable by a user to report the rotational orientation of the display device.

36. An apparatus for reporting the rotation orientation of a display device, comprising:
a passive radio transponder adapted to be attached to the display device; and
an active radio transceiver adapted to (a) determine, from a position proximate to the display device, the rotational orientation of the display device based upon radio communications with the passive radio transponder and (b) communicate the determined rotational orientation to a receiver.

37. The apparatus of claim 36 wherein the receiver is a video source that is configured to provide a video signal to the display device.

38. The apparatus of claim 36 wherein the passive radio transponder communicates with the active radio transceiver using one single-dipole antenna.

39. The apparatus of claim 36 wherein the passive radio transponder communicates with the active radio transceiver using multiple dual-dipole antennas.

40. The apparatus of claim 36 wherein the receiver is a personal computer, and wherein the active radio transceiver is mounted on an expansion card adapted for installation in the personal computer.
